(19) United States
(12) Patent Application Publication
(10) Pub. No.: US 2024/0223053 A1
(43) Pub. Date: Jul. 4, 2024

(54) SYNCHRONOUS RELUCTANCE MOTOR AND PUMP DEVICE

(71) Applicants: TOSHIBA INDUSTRIAL PRODUCTS AND SYSTEMS CORPORATION, Kawasaki-shi, Kanagawa (JP); TOSHIBA INFRASTRUCTURE SYSTEMS & SOLUTIONS CORPORATION, Kawasaki-shi, Kanagawa (JP)

(72) Inventors: Shinichi ICHIKAWA, Mie-gun (JP); Masayuki KAWAKAMI, Mie-gun (JP); Yuji YAMAMOTO, Mie-gun (JP); Makoto MATSUSHITA, Kawasaki-shi (JP); Katsutoku TAKEUCHI, Kawasaki-shi (JP)

(73) Assignees: TOSHIBA INDUSTRIAL PRODUCTS AND SYSTEMS CORPORATION, Kawasaki-shi, Kanagawa (JP); TOSHIBA INFRASTRUCTURE SYSTEMS & SOLUTIONS CORPORATION, Kawasaki-shi, Kanagawa (JP)

(21) Appl. No.: 18/558,403

(22) PCT Filed: Mar. 2, 2022
(86) PCT No.: PCT/JP2022/008870

§ 371 Date: Nov. 1, 2023

(30) Foreign Application Priority Data
May 28, 2021 (JP) 2021-090154

(51) Int. Cl. H02K 21/14; H02K 1/276; H02K 7/14

(52) U.S. Cl. CPC H02K 21/14; H02K 1/2766; H02K 7/14

(57) ABSTRACT

A synchronous reluctance motor of an embodiment includes a columnar rotor iron core at a center of which a rotary shaft is disposed, and a flux barrier slit group provided for each magnetic pole of the rotor iron core, the slit group includes an outer layer slit disposed along an outer circumferential edge portion of the rotor iron core, and an inner layer slit having both end portions positioned close to an outer circumference of the rotor iron core on opposite sides of the outer layer slit in a circumferential direction, the inner layer slit having a curved shape that is convex toward a central side of the rotor iron core, and a permanent magnet is disposed in the inner layer slit.

### TECHNICAL FIELD

Embodiments of the present invention relate to a synchronous reluctance motor capable of self-starting, and a pump device incorporating the motor.

### BACKGROUND ART

A synchronous reluctance motor driven by commercial power supplies is known as a motor integrally incorporated in a pump device, for example, a hydraulic pump device to serve as a drive source. As this type of synchronous reluctance motor, for example, a synchronous reluctance motor including a configuration described in Patent Literature 1 is known. This synchronous reluctance motor includes a stator around which a three-phase winding is wound, a cylindrical rotor iron core disposed on an inner circumference of the stator and formed of laminated silicon steel plates, and slits for a flux barrier that are formed, for example, in four layers for each magnetic pole. The respective slits are formed in a curved shape having both end portions positioned near an outer circumference of the rotor iron core and being convex on a central side.

### CITATION LIST

### Patent Literature

Patent Literature 1: Japanese Patent Laid-Open No. 2018-78767

### SUMMARY OF INVENTION

### Technical Problem

In such a synchronous reluctance motor as described above, in general, there is a problem that an inverter is required for starting, at high cost. Therefore, a secondary conductor is provided in a slit for a flux barrier of a rotor iron core by filling the slit with a non-magnetic metal such as aluminum or copper, to generate induction torque, thereby providing the motor with a self-starting function. The motor thus provided with the secondary conductor, however, has efficiency reduced.

To solve the problem, a synchronous reluctance motor capable of self-starting and obtaining high efficiency and a pump device using the synchronous reluctance motor are provided.

### Solution to Problem

A synchronous reluctance motor of an embodiment is capable of self-starting and includes a columnar rotor iron core at a center of which a rotary shaft is disposed, and a flux barrier slit group provided for each magnetic pole of the rotor iron core, the slit group includes an outer layer slit disposed along an outer circumferential edge portion of the rotor iron core, and an inner layer slit having both end portions positioned close to an outer circumference of the rotor iron core on opposite sides of the outer layer slit in a circumferential direction, the inner layer slit having a curved shape that is convex toward a central side of the rotor iron core, and a permanent magnet is disposed in the inner layer slit.

### BRIEF DESCRIPTION OF DRAWINGS

FIG. 1 is a cross-sectional view schematically showing an internal configuration of a synchronous reluctance motor in a range of an angle of 90 degrees according to a first embodiment.

FIG. 2 is a diagram schematically showing an appearance of a pump device.

FIG. 3 is a diagram showing arrangement of configurations of models of rotor iron cores according to Example and Comparative Examples 1 to 3.

FIG. 4 is a diagram showing starting torque waveforms for four types of models.

FIG. 5 is a diagram showing change in average torque against slip for the four types of models.

FIG. 6 is a diagram showing change in pulsation torque against slip for the four types of models.

FIG. 7 is a diagram showing analysis results of synchronous pull-in characteristics of the four types of models.

FIG. 8 is a cross-sectional view schematically showing an internal configuration of a synchronous reluctance motor in a range of an angle of 90 degrees according to a second embodiment.

### DESCRIPTION OF EMBODIMENTS

### (1) First Embodiment

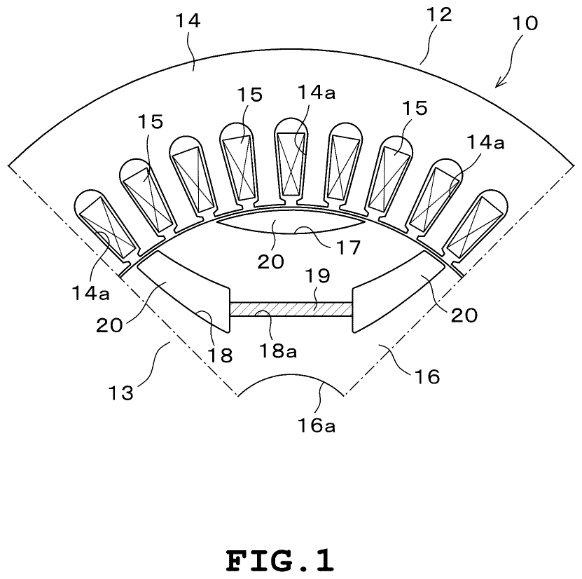

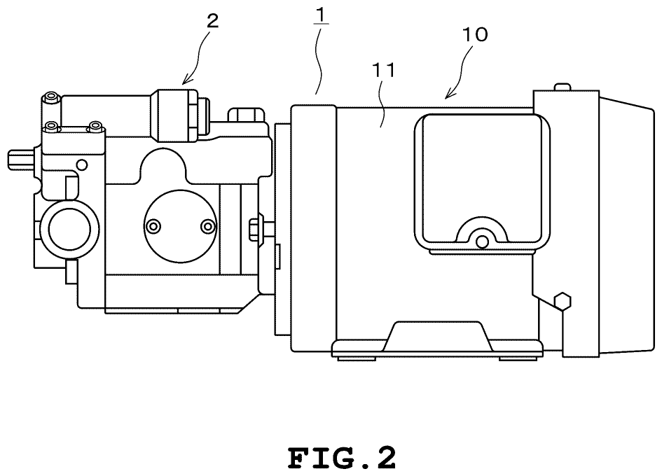

Hereinafter, a first embodiment will be described with reference to FIGS. 1 to 7. First, FIG. 2 schematically shows a configuration of a pump device 1 according to the present embodiment. The pump device 1 includes, for example, a pump body 2 including a hydraulic pump, and a synchronous reluctance motor 10 according to the present embodiment that serves as a drive source for the pump body 2. In this case, the synchronous reluctance motor 10 is integrally coupled to the pump body 2, and an unshown rotary shaft of the synchronous reluctance motor 10 is configured to directly drive the pump body 2.

As shown in FIG. 1, the synchronous reluctance motor 10 according to the present embodiment is, for example, configured such that a stator 12 is attached to an inner circumferential surface of a cylindrical frame 11, and a rotor 13 is disposed via a slight air gap in an inner circumferential portion of the stator 12. The stator 12 is configured such that a three-phase winding 15 is attached to a stator iron core 14 including a plurality of, for example, 36 slots 14a.

The rotor 13 includes, for example, a columnar rotor iron core 16 having magnetic saliency of four poles, and the unshown rotary shaft penetrating a central portion of the rotor iron core 16 is fixed and is rotatably supported on brackets at both ends of the frame 11. The rotor iron core 16 is configured by laminating a large number of electromagnetic steel plates in an axial direction and has a central hole 16a in which the rotary shaft is disposed at a center of the rotor iron core. Further, in a region constituting each magnetic pole of the rotor iron core 16, that is, each of regions divided into four at an angle of 90 degrees in a circumferential direction, a slit group for a flux barrier including two slits in this case is provided as follows.

Specifically, as shown in FIG. 1, the rotor iron core 16 is provided with an outer layer slit 17 positioned on an outer circumferential side, and an inner layer slit 18 positioned on an inner circumferential side of the outer layer slit 17. Of the slits, the outer layer slit 17 is provided at a position in a range of a central portion of approximately ⅓ of the region having an angle of 90 degrees in a portion extending along an outer circumferential edge portion of the rotor iron core 16. The outer layer slit 17 has such a shape that two arcs each extending along an outer circumferential edge of the rotor iron core 16 are symmetrically aligned with each other, the shape including a swollen center and both rounded and pointed ends. That is, the outer layer slit has a so-called lens shape or a comparatively narrow leaf shape. The outer layer slit 17 is filled with a non-magnetic metal material 20 made of, for example, aluminum. An interior of the outer layer slit 17 may be hollow.

The inner layer slit 18 has both end portions positioned close to the outer circumference of the rotor iron core 16 on opposite sides of the outer layer slit 17 in the circumferential direction and is convex as a whole toward a central side of the rotor iron core 16, that is, toward a central hole 16a side, thereby forming a curved shape. In the inner layer slit 18, a length portion of approximately ⅓ of an intermediate portion is a narrow portion 18a extending almost linearly so as to be orthogonal to the rotor iron core 16 in a radial direction. In the inner layer slit 18, approximately ⅓ portions on opposite sides extend slightly wider than the narrow portion 18a and curved, and both end portions positioned near the outer circumference of the rotor iron core 16 are configured as strips with slightly rounded corners.

In the inner layer slit 18, a permanent magnet 19 is attached to an interior of the narrow portion 18a, that is, a central portion of the inner layer slit 18. In this case, the permanent magnet 19 is provided, for example, with a side facing the outer circumference of the rotor iron core 16 as an S pole and a side facing the inner circumference of the rotor iron core as an N pole, or conversely, provided with the outer circumferential side as the N pole and the inner circumferential side as the S pole. In the inner layer slit 18, portions other than a portion in which the permanent magnet 19 is contained are filled with the non-magnetic metal material 20 made of, for example, aluminum. The other portions may be hollow. In the rotor iron core 16, an arc-shaped portion between the outer layer slit 17 and the inner layer slit 18, that is, a portion through which q-axis current flows is configured to be comparatively wide.

The synchronous reluctance motor 10 of the present embodiment configured as described above utilizes both a reluctance torque by the outer layer slit 17 and inner layer slit 18 for the flux barrier and a magnet torque due to the permanent magnet 19 and can therefore be superior in self-starting characteristics, and efficiency during synchronous rotation, while having the comparatively small permanent magnet 19. The present inventors have found that the synchronous reluctance motor 10 according to the above-described embodiment is particularly adapted to load characteristics when starting the pump device 1 having a small moment of inertia and is capable of self-starting with commercial power supplies and operating highly efficiently at synchronous speed.

In the above configuration, the rotor iron core 16 includes two layers of slits 17 and 18, but unlike a case where four layers of slits are provided, for example, a magnetic path between the outer layer slit 17 and the inner layer slit 18 can be widened to facilitate flow of q-axis magnetic flux. This can increase average torque and increase efficiency. Then, due to presence of the magnet torque by the permanent magnet 19, a pulsation torque increases. Increasing the pulsation torque can improve synchronous pull-in characteristics and can greatly improve starting characteristics.

The present inventors have repeated various tests and research regarding the flux barrier of the rotor iron core of the synchronous reluctance motor. Specifically, for four types of models that are different in numbers and forms of the slits for the flux barrier and that include the rotor iron core 16 of the synchronous reluctance motor 10 according to the above present embodiment, in particular, the starting torque and synchronous pull-in characteristics have been investigated, and effectiveness of the synchronous reluctance motor 10 according to the present embodiment has been verified. Hereinafter, analysis of the starting torque and synchronous pull-in characteristics will be described.

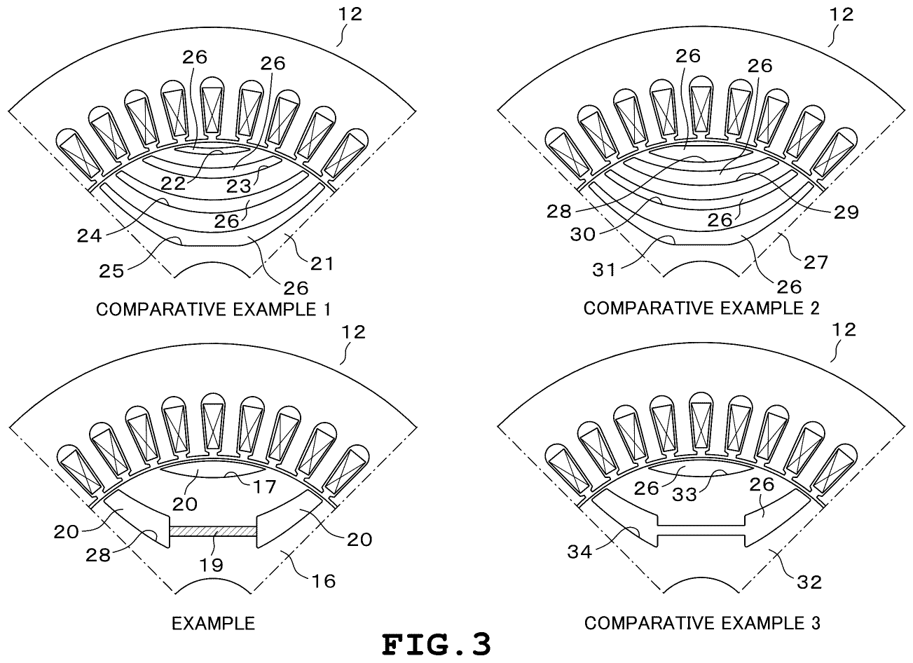

FIG. 3 shows four types of models used for the analysis. Comparative Example 1 is a conventional common synchronous reluctance motor that is started by an inverter and includes slits for a flux barrier, and four layers of slits 22, 23, 24 and 25 for the flux barrier are formed in a rotor iron core 21. Further, each of the slits 22 to 25 is filled with a non-magnetic metal material, for example, aluminum 26. The aluminum 26 in each of the slits 22 to 25 is connected in an end portion of the rotor iron core 21 and is configured as a squirrel cage conductor.

Comparative Example 2 is a synchronous reluctance motor that is also started by an inverter, and four layers of slits 28, 29, 30 and 31 for a flux barrier are formed in a rotor iron core 27. Each of the slits 28 to 31 is filled with, for example, aluminum 26, to constitute a squirrel cage conductor. In Comparative Example 2, the slit 28 of the outermost layer is larger and an area of aluminum 26 is larger than in Comparative Example 1.

Example is the synchronous reluctance motor 10 described above. In Comparative Example 3, an outer layer slit 33 and an inner layer slit 34 are formed in a rotor iron core 32 as in the rotor iron core 16 of Example, and the slits 33 and 34 are filled with aluminum 26, for example. That is, the aluminum 26 is provided in the rotor iron core 16 of Example, except the permanent magnet 19 in the inner layer slit 18.

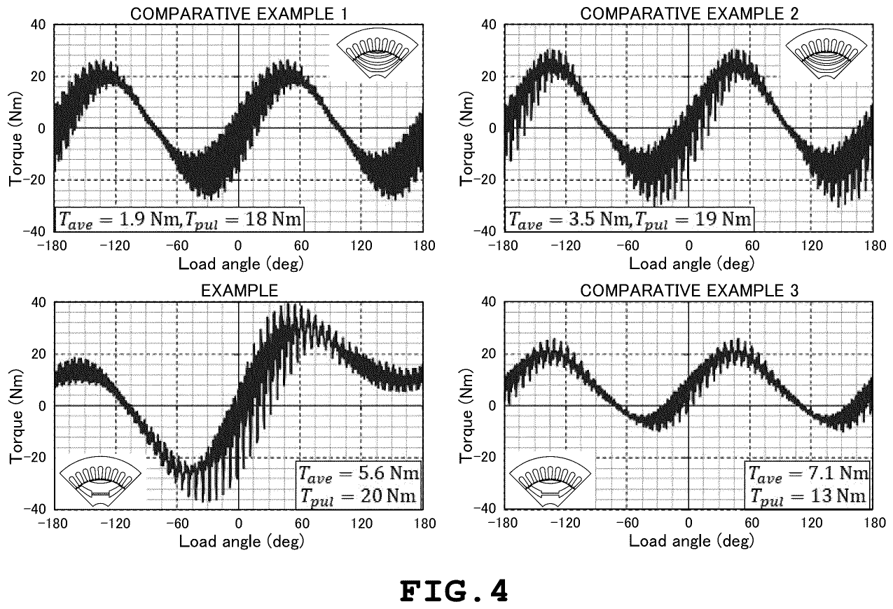

For the above four types of models, the starting torque was analyzed by the following procedure. Specifically, a three-phase voltage of 200V-60 Hz is applied to rotate the motor at slip represented by s. The torque is then analyzed until the torque changes steadily. For example, 5401 steps for 0.5 seconds. Then, average torque Tave and pulsation torque Tpul, that is, amplitudes of fundamental wave components are calculated. FIG. 4 shows starting torque waveforms at slip of 0.1 for four types of models. As can be understood from FIG. 4, a ratio of an average component and a pulsation component differs with each model. Further, only Example in which the permanent magnet 19 is inserted is different in fundamental wave period of pulsation.

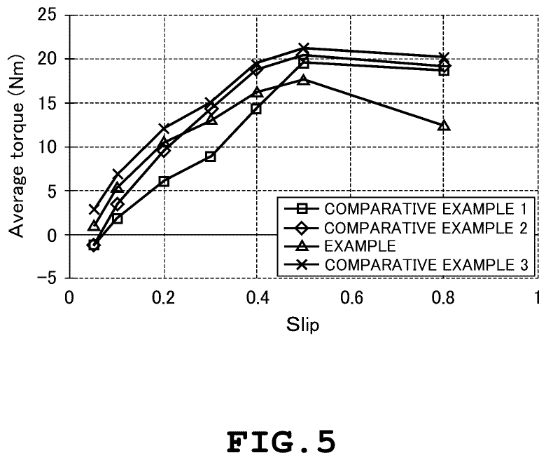

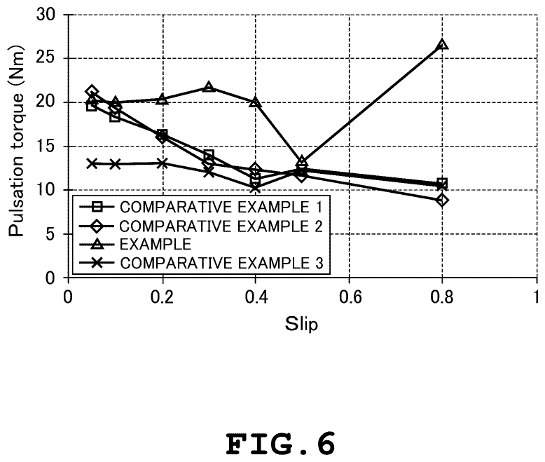

FIGS. 5 and 6 show changes in starting torque in response to slip examined for the above four types of models, and FIGS. 5 and 6 show the average torque and the pulsation torque, respectively. As is clear from these drawings, in Comparative Example 1, a conductor area of an outermost layer is small, and hence the average torque is small. In Comparative Example 2, compared to Comparative Example 1, the conductor area of the outermost layer is larger, and the average torque improves. In Example, compared to Comparative Examples 1 and 2, the magnetic path of the rotor iron core has a larger width, the q-axis magnetic flux is easier to flow, and the average torque is therefore slightly larger. Furthermore, since there is a magnet torque due to the permanent magnet, the pulsation torque is also larger than those of Comparative Examples 1 to 3. Comparative Example 3 has a large average torque due to a large magnetic path width but has small saliency and therefore has the pulsation torque smaller than that of Example.

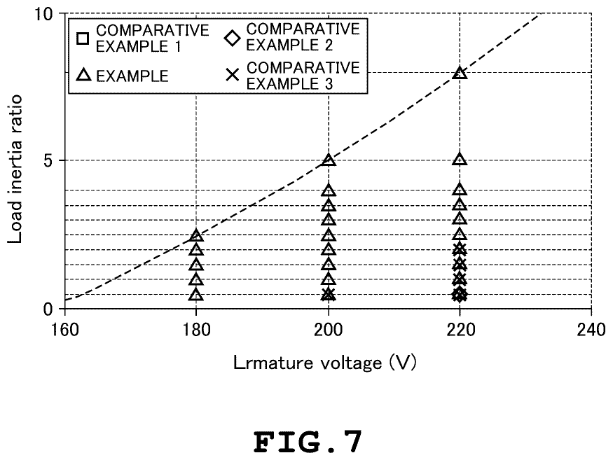

FIG. 7 shows analysis results of synchronous pull-in characteristics of the above four types of models. The analysis is made on conditions including a frequency of 60 Hz, a winding temperature, a magnet temperature of 80° ° C., and the like. As is clear from FIG. 7, in the motor of Example, compared to Comparative Examples 1 to 3, the synchronous pull-in characteristics greatly improve, and the result is that the motor can start up as much as about five times. In addition, when the voltage is low, starting characteristics tend to decrease slightly. The motor of this model is set to the number of turns of 54.67 turns instead of 48 turns, and hence Comparative Examples 1 and 2 have less operation points that can be pulled in. In the case of 48 turns, the starting characteristics are equivalent to 227 V.

Here, in the motor of Example, as shown in FIGS. 5 and 6, the starting torque is improved compared to Comparative Examples 1 to 3 but cannot be considered to be significantly improved. The reason the synchronous pull-in characteristics of the motor containing the permanent magnet 19 in the inner layer slit 18 are greatly improved is considered as follows. That is, an oscillation equation of the synchronous motor is given by the following equation (1).

$$\begin{matrix}[ Expression 1 ] & \\ \frac{2}{p} \frac{{d}^{2} δ}{{dt}^{2}} = \frac{{T}_{pul}}{J} & ( 1 )\end{matrix}$$

wherein δ is a load angle, t is time, J is a total moment of inertia, and p is the number of poles.

Here, in the case of the reluctance torque (Trel), Tpul=Trel·sin²δ, and in the case of the magnet torque (Tmag), Tpul=Tmag·sin δ.

Considering that fluctuation component Δωm of a rotation speed is approximately equal to a change rate of the load angle, the following equation (2) is obtained.

$$\begin{matrix}[ Expression 2 ] & \\ {Δω}_{m} \approx \frac{2}{p} \frac{d δ}{dt} = \frac{1}{J} \int {T}_{pul} dt = \{ \begin{matrix}- \frac{{T}_{rel}}{J} cos 2 δ & … in the case of reluctance torque \\ - \frac{2 {T}_{mag}}{J} cos δ & … in the case of magnet torque\end{matrix} & ( 2 )\end{matrix}$$

As can be understood from this equation (2), even if the amplitude as the pulsation torque is the same, the magnet torque has a period twice longer than the reluctance torque and gives twice the velocity pulsation. It is therefore considered that the magnet torque is twice as effective as the reluctance torque for the synchronous pull-in characteristics.

Thus, according to the present embodiment, by making use of both the reluctance torque due to the slits 17 and 18 for the flux barrier and the magnet torque due to the permanent magnet 19, the synchronous reluctance motor 10 capable of self-starting with commercial power supplies and operating highly efficiently at the synchronous speed can be provided at low cost. Furthermore, the synchronous reluctance motor 10 including the above configuration is particularly adapted to the load characteristics when starting the pump device 1, and by incorporating the synchronous reluctance motor 10 in the pump body 2, the pump device 1 superior in starting characteristics and efficiency can be provided at low cost.

### (2) Second Embodiment and Other Embodiments

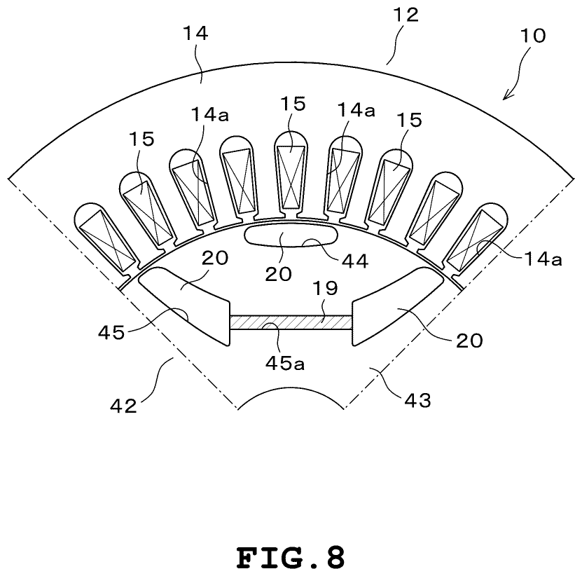

FIG. 8 shows an internal configuration of a synchronous reluctance motor 41 according to a second embodiment, which differs from the synchronous reluctance motor 10 of the above first embodiment in the following respects. Specifically, a rotor 42 disposed in an inner circumferential portion of a stator 12 includes a columnar rotor iron core 43 formed of a large number of laminated electromagnetic steel plates in an axial direction and having magnetic saliency of four poles.

The rotor iron core 43 includes a central hole 43a in which a rotary shaft is disposed, at a center of the rotor iron core. Then, an outer layer slit 44 and an inner layer slit 45 for a flux barrier are provided in a region constituting each pole of the rotor iron core 43, that is, each of regions divided into four at an angle of 90 degrees in a circumferential direction. A length portion that is an intermediate portion of approximately ⅓ of the inner layer slit 45 is a narrow portion 45a extending almost linearly, and a permanent magnet 19 is attached to an interior of the narrow portion 45a, that is, a central portion of the inner layer slit 45. An interior of the outer layer slit 44 and portions of the inner layer slit 45, other than a portion in which the permanent magnet 19 is contained, are filled with a non-magnetic metal material 20 made of, for example, aluminum. The other portions may be hollow.

At this time, in the present embodiment, fillet radiuses of corners of end portions of the outer layer slit 44 and the inner layer slit 45 are larger than those of the outer layer slit 17 and the inner layer slit 18 of the above first embodiment. Thereby, the outer layer slit 44 and the inner layer slit 45 have more rounded shapes in the corners of the end portions. Here, in a self-starting synchronous reluctance motor, in general, due to need to provide a large conductor portion in the outer circumferential portion of the rotor iron core, large magnetic unevenness is generated in the rotor, and torque ripples increase. Despite these circumstances, in the configuration of this second embodiment, it has been confirmed that the torque ripples can be sufficiently reduced by increasing the fillet radius of each of the corners of the end portions of the outer layer slit 44 and the inner slit 45.

Thus, according to the second embodiment, as in the above first embodiment, the synchronous reluctance motor 41 capable of self-starting with commercial power supplies and operating highly efficiently at a synchronous speed can be provided. In addition, the shapes of the outer layer slit 44 and the inner layer slit 45 can reduce the magnetic unevenness of the rotor 42 to decrease the torque ripples.

In the above embodiments, the intermediate portions of the inner layer slits 18 and 45 are formed as the linear narrow portions 18a and 45a, and the permanent magnets 19 are disposed in the narrow portions 18a and 45a. Alternatively, a permanent magnet formed in a gentle arc shape may be disposed in an arc-shaped inner layer slit. For a thickness dimension of the permanent magnet, a permanent magnet having a comparatively large thickness can be adopted in consideration of demagnetization. The permanent magnet can have a length that can be variously changed. Needless to say, specific numerical values such as the number of slots of the stator and the number of magnetic poles of the rotor can be changed as appropriate.

In addition, the synchronous reluctance motor can be applied not only to the hydraulic pump but also to various pump devices and can also be used for purposes other than the pump devices. Although some embodiments of the present invention have been described above, these embodiments are presented by way of examples and are not intended to limit the scope of the invention. These novel embodiments can be implemented in various other forms, and various omissions, replacements, and changes can be made without departing from the gist of the invention. These embodiments and variations thereof are included in the scope and gist of the invention and included in the invention described in the claims and their equivalents.

1. A synchronous reluctance motor being capable of self-starting and comprising:
a columnar rotor iron core at a center of which a rotary shaft is disposed; and
a flux barrier slit group provided for each magnetic pole of the rotor iron core, wherein
the slit group includes an outer layer slit disposed along an outer circumferential edge portion of the rotor iron core, and an inner layer slit having both end portions positioned close to an outer circumference of the rotor iron core on opposite sides of the outer layer slit in a circumferential direction, the inner layer slit having a curved shape that is convex toward a central side of the rotor iron core, and
a permanent magnet is disposed in the inner layer slit.

2. The synchronous reluctance motor according to claim 1, wherein the permanent magnet is disposed in a central portion of the inner layer slit.

3. The synchronous reluctance motor according to claim 1, wherein in the slit group, portions other than a portion in which the permanent magnet is contained are hollow or are filled with a non-magnetic material.

4. A pump device comprising:
a pump body, and
the synchronous reluctance motor according to claim 1, which is a motor serving as a drive source of the pump body.

5. The synchronous reluctance motor according to claim 2, wherein in the slit group, portions other than a portion in which the permanent magnet is contained are hollow or are filled with a non-magnetic material.

6. A pump device comprising:
a pump body, and
the synchronous reluctance motor according to claim 2, which is a motor serving as a drive source of the pump body.

7. A pump device comprising:
a pump body, and
the synchronous reluctance motor according to claim 3, which is a motor serving as a drive source of the pump body.

8. A pump device comprising:
a pump body, and
the synchronous reluctance motor according to claim 5, which is a motor serving as a drive source of the pump body.
